(19) United States
(12) Patent Application Publication
(10) Pub. No.: US 2026/0229782 A1
(43) Pub. Date: Aug. 6, 2026

(54) ANTENNA SUBSTRATE, AND ANTENNA MODULE AND COMMUNICATION APPARATUS INCLUDING THE SAME

(71) Applicant: Murata Manufacturing Co., Ltd., Nagaokakyo-shi (JP)

(72) Inventors: Hideaki YAMASHITA, Nagaokakyo-shi (JP); Ryo KOMURA, Nagaokakyo-shi (JP); Kengo ONAKA, Nagaokakyo-shi (JP)

(73) Assignee: Murata Manufacturing Co., Ltd., Nagaokakyo-shi (JP)

(21) Appl. No.: 19/655,714

(22) Filed: Apr. 23, 2026

Related U.S. Application Data
(63) Continuation of application No. PCT/JP2024/040940, filed on Nov. 19, 2024.

(30) Foreign Application Priority Data
Nov. 28, 2023 (JP) 2023-200489

(51) Int. Cl. H01Q 9/04; H01Q 21/24

(52) U.S. Cl. CPC H01Q 9/045; H01Q 21/24

(57) ABSTRACT

An antenna substrate includes a plate-shaped dielectric with a main surface and a side surface, a plate-shaped radiating element arranged in parallel to the main surface of the plate-shaped dielectric, and a first terminal exposed at least partially at the side surface of the dielectric, wherein with a direction along a normal to the radiating element being defined as a first direction and with two directions orthogonal to the first direction and orthogonal to each other being defined as a second direction and a third direction, the first terminal includes a portion that does not overlap with the radiating element when viewed from the first direction and overlaps with the radiating element when viewed from both of the second direction and the third direction.

### CROSS-REFERENCE TO RELATED APPLICATIONS

This application is a continuation of PCT Application No. PCT/JP2024/040940, filed on November 19, 2024, which claims priority to Japanese Patent Application No. 2023-200489, filed on November 28, 2023. The entire contents of each of the above-listed applications are incorporated herein by reference.

### TECHNICAL FIELD

The present disclosure relates to an antenna substrate, and an antenna module and a communication apparatus including the same.

### BACKGROUND ART

Japanese Patent Laid-Open No. 2004-274259 (PTL 1) discloses an antenna substrate. The antenna substrate includes a plate-shaped patch (radiating element) arranged at an upper surface of a plate-shaped dielectric and an external connection terminal.

### CITATION LIST

### PATENT LITERATURE

PTL 1: Japanese Patent Laid-Open No. 2004-274259

### SUMMARY

An antenna substrate includes a plate-shaped dielectric with a main surface and a side surface, a plate-shaped radiating element arranged in parallel to the main surface of the plate-shaped dielectric, and a first terminal exposed at least partially at the side surface of the dielectric, wherein with a direction along a normal to the radiating element being defined as a first direction and with two directions orthogonal to the first direction and orthogonal to each other being defined as a second direction and a third direction, the first terminal includes a portion that does not overlap with the radiating element when viewed from the first direction and overlaps with the radiating element when viewed from both of the second direction and the third direction.

### BRIEF DESCRIPTION OF DRAWINGS

FIG. 1 is an exemplary block diagram of a communication apparatus including an antenna substrate.

FIG. 2 is a perspective view of an antenna apparatus.

FIG. 3 is a perspective view (No. 1) of the antenna substrate.

FIG. 4 is a perspective view (No. 2) of the antenna substrate.

FIG. 5 is a diagram (No. 1) showing antenna characteristics.

FIG. 6 is a diagram (No. 2) showing antenna characteristics.

FIG. 7 is a diagram (No. 3) showing antenna characteristics.

FIG. 8 is a diagram showing antenna characteristics in wired power feed and antenna characteristics in capacitive power feed.

FIG. 9 is a diagram schematically showing an operation mode in capacitive power feed.

FIG. 10 is a diagram (No. 1) showing an exemplary configuration of the antenna substrate.

FIG. 11 is a diagram (No. 2) showing an exemplary configuration of the antenna substrate.

FIG. 12 is a diagram (No. 3) showing an exemplary configuration of the antenna substrate.

FIG. 13 is a diagram (No. 4) showing an exemplary configuration of the antenna substrate.

FIG. 14 is a diagram (No. 5) showing an exemplary configuration of the antenna substrate.

FIG. 15 is a diagram (No. 6) showing an exemplary configuration of the antenna substrate.

FIG. 16 is a diagram (No. 7) showing an exemplary configuration of the antenna substrate.

FIG. 17 is a diagram (No. 8) showing an exemplary configuration of the antenna substrate.

FIG. 18 is a diagram (No. 9) showing an exemplary configuration of the antenna substrate.

FIG. 19 is a partial perspective view (No. 1) of an antenna module.

FIG. 20 is a partial perspective view (No. 2) of the antenna module.

### DESCRIPTION OF EMBODIMENTS

With increasing functionality of communication terminals such as smartphones in recent years, a space for mounting antenna substrates in the communication terminals tends to be limited. For example, in PTL1, the antenna substrate includes an external connection terminal that is exposed at a side surface of a dielectric, and is arranged at a position where it does not overlap with the radiating element when viewed from a direction normal to a main surface of the dielectric. However, reduction in size of the antenna substrate has been desired. Furthermore, expansion of coverage (a range in which radio waves can be transmitted and received) of the antenna substrate has also been desired.

The present disclosure was made in view of the above circumstances, and is directed toward expanding coverage while an antenna substrate including a plate-shaped (e.g., flat) radiating element (patch) arranged at a main surface of a dielectric and a terminal (external connection terminal) arranged as being exposed at a side surface of the dielectric is reduced in size.

An antenna module in the present disclosure includes the antenna substrate described above. A communication apparatus in the present disclosure includes the antenna module described above.

An embodiment in the present disclosure will be described in detail below with reference to the drawings. The same or corresponding elements in the drawings have the same reference characters allotted and description thereof will not be repeated.

### Basic Configuration of Communication Apparatus

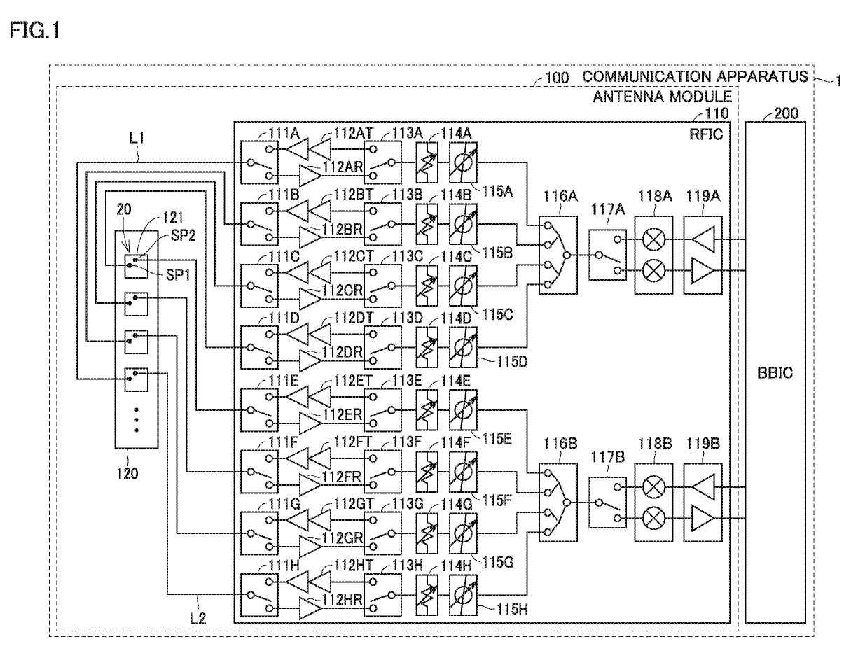

FIG. 1 is an exemplary block diagram of a communication apparatus 1 including an antenna substrate 20 according to the present embodiment. Communication apparatus 1 is, for example, a portable terminal such as a mobile phone, a smartphone, a tablet, a personal computer provided with a communication function, or the like. An exemplary frequency band of radio waves used for antenna substrate 20 according to the present embodiment is a millimeter-wave band having center frequencies, for example, of 28 GHz, 39 GHz, 60 GHz, and the like. Radio waves in frequency bands other than the above, however, are also applicable.

Referring to FIG. 1, communication apparatus 1 includes an antenna module 100 and a baseband integrated circuit 200 (i.e., a BBIC 200) which implements a baseband signal processing circuit. Antenna module 100 includes a radio frequency integrated circuit 110 (i.e., an RFIC 110) which is an exemplary power feed apparatus and an antenna apparatus 120.

Communication apparatus 1 up-converts a signal transmitted from BBIC 200 to antenna module 100 to a radio-frequency signal in RFIC 110, and radiates the resultant signal from antenna apparatus 120. Communication apparatus 1 transmits a radio-frequency signal received by antenna apparatus 120 to RFIC 110, down-converts the radio-frequency signal, and processes the resultant signal in BBIC 200.

Antenna module 100 is what is called a dual polarization type antenna module capable of radiating two radio waves different in polarization direction from each other. Antenna apparatus 120 includes a plurality of antenna substrates 20 each including a plurality of radiating elements 121. Each radiating element 121 is a plate-shaped patch antenna. In FIG. 1, for the sake of facilitated description, only a configuration corresponding to four radiating elements 121 among the plurality of radiating elements 121 included in antenna apparatus 120 is shown, and configurations corresponding to other radiating elements 121 similar in configuration are omitted.

Each of radiating elements 121 is provided with a first power feed point SP1 to which a radio-frequency signal for a first polarization is supplied from RFIC 110 and a second power feed point SP2 to which a radio-frequency signal for a second polarization is supplied from RFIC 110. Antenna module 100 is not limited to a dual polarization type antenna module, and may be a single polarization type antenna module.

RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal combiners/splitters 116A and 116B, mixers 118A and 118B, and amplifier circuits 119A and 119B. Among these, features including switches 111A to 111D, 113A to 113D, and 117A, power amplifiers 112AT to 112DT, low-noise amplifiers 112AR to 112DR, attenuators 114A to 114D, phase shifters 115A to 115D, signal combiner/splitter 116A, mixer 118A, and amplifier circuit 119A are circuits for a radio-frequency signal for first polarization. Features including switches 111E to 111H, 113E to 113H, and 117B, power amplifiers 112ET to 112HT, low-noise amplifiers 112ER to 112HR, attenuators 114E to 114H, phase shifters 115E to 115H, signal combiner/splitter 116B, mixer 118B, and amplifier circuit 119B are circuits for a radio-frequency signal for second polarization.

In transmission of a radio-frequency signal, switches 111A to 111H and 113A to 113H are switched to a side of power amplifiers 112AT to 112HT and switches 117A and 117B are connected to a transmission-side amplifier of amplifier circuits 119A and 119B. In reception of a radio-frequency signal, switches 111A to 111H and 113A to 113H are switched to a side of low-noise amplifiers 112AR to 112HR and switches 117A and 117B are connected to a reception-side amplifier of amplifier circuits 119A and 119B.

A signal transmitted from BBIC 200 is amplified by amplifier circuit 119A, 119B and up-converted by mixer 118A, 118B. A transmission signal, which is an up-converted radio-frequency signal, is split into four signals by signal combiner/splitter 116A, 116B, and the resultant signals pass through corresponding signal paths and are fed to different radiating elements 121.

Reception signals, which are radio-frequency signals received by respective radiating elements 121, are transmitted to RFIC 110 and combined in signal combiner/splitter 116A, 116B through four different signal paths. The combined reception signal is down-converted by mixer 118A, 118B and amplified by amplifier circuit 119A, 119B and transmitted to BBIC 200.

RFIC 110 is formed, for example, as a single-chip integrated circuit component including the circuit configuration described above. Alternatively, a device (the switch, the power amplifier, the low-noise amplifier, the attenuator, and the phase shifter) corresponding to each radiating element 121 in RFIC 110 may be formed as a single-chip integrated circuit component for each corresponding radiating element 121.

### Structure of Antenna Apparatus

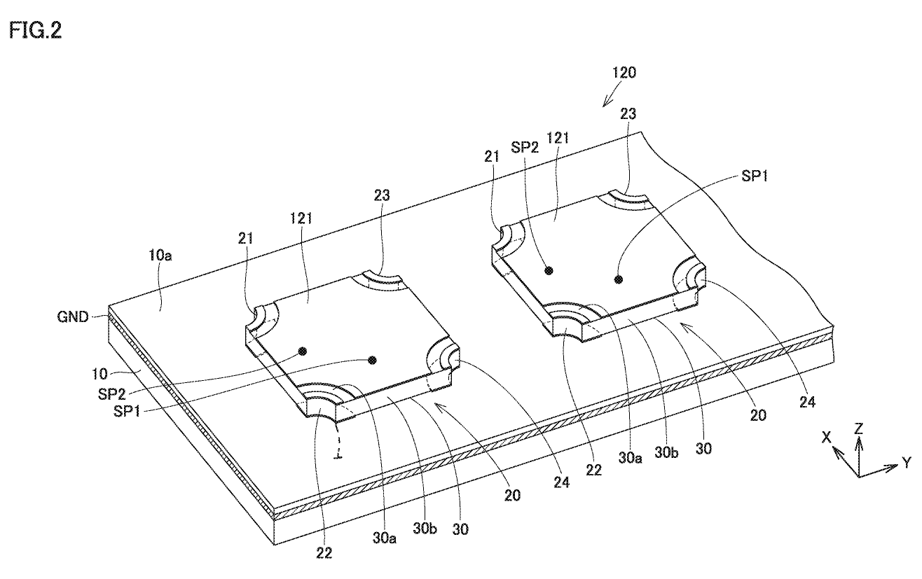

FIG. 2 is a perspective view of antenna apparatus 120. Antenna apparatus 120 includes a dielectric base substrate 10 and a plurality of antenna substrates 20.

Base substrate 10 has a shape of a substantially rectangular parallelepiped. Base substrate 10 includes a plate-shaped ground electrode GND extending along a main surface 10a (e.g., the ground electrode GND may be a layer embedded within the dielectric 30).

The plurality of antenna substrates 20 are mounted, while being aligned, on main surface 10a of base substrate 10. Each of the plurality of antenna substrates 20 includes a plate-shaped dielectric 30, a radiating element 121 on a main surface 30a (e.g., an upper surface) of the plate-shaped dielectric 30, and four external connection terminals 21 to 24. Each of external connection terminals 21 to 24 is arranged such that a part thereof is exposed at a side surface 30b of dielectric 30.

A direction of normal to radiating element 121 (that is, the direction of normal to a main surface 30a of dielectric 30) is also referred to as a "Z-axis direction" below and two directions orthogonal to the Z-axis direction and orthogonal to each other are also referred to as an "X-axis direction" and a "Y-axis direction" below. In the present embodiment, an example is shown in which a direction of a short side and a longitudinal direction of main surface 10a of base substrate 10 are defined as the X-axis direction and the Y-axis direction, respectively.

The description below may be given, with a positive direction along a Z axis in each FIGURE(the direction from base substrate 10 toward antenna substrate 20) being referred to as "up(ward)" and a negative direction along the Z axis (the direction from antenna substrate 20 toward base substrate 10) being referred to as "down(ward)".

The plurality of antenna substrates 20 are arranged in an array on main surface 10a (e.g., an upper surface) of base substrate 10 as being aligned in the Y-axis direction at predetermined intervals. An antenna gain is thus improved as compared to an example where a single radiating element 121 is arranged.

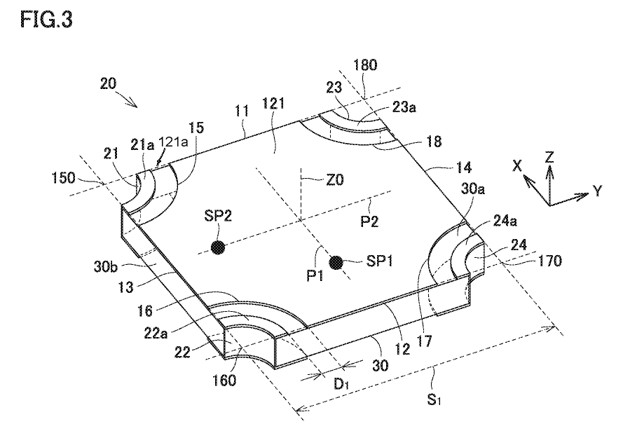

FIG. 3 is a perspective view of antenna substrate 20. As described above, radiating element 121 is provided with first power feed point SP1 to which a radio-frequency signal for first polarization is supplied and second power feed point SP2 to which a radio-frequency signal for second polarization is supplied.

A straight line P1 (i.e., a virtual line) connecting first power feed point SP1 and a center of radiating element 121 to each other and a straight line P2 (i.e., a virtual line) connecting second power feed point SP2 and the center of radiating element 121 to each other are orthogonal to each other. In the present embodiment, since first power feed point SP1 is arranged at a position offset in the negative direction along the X-axis from the center of radiating element 121, straight line P1 extends in the X-axis direction. Since second power feed point SP2 is arranged at a position offset in the negative direction along the Y axis from the center of radiating element 121, straight line P2 extends in the Y-axis direction. As the radio-frequency signal for first polarization is supplied to first power feed point SP1, a first radio wave having a polarization direction in a direction along straight line P1 (the X-axis direction in the present embodiment) is radiated from radiating element 121. As the radio-frequency signal for second polarization is supplied to second power feed point SP2, a second radio wave having a polarization direction in a direction along straight line P2 (the Y-axis direction in the present embodiment) is radiated from radiating element 121.

Radiating element 121 has a shape having a side 11, a side 12 opposed to side 11, and sides 13 and 14 extending in parallel to each other and being orthogonal to side 11 when viewed from the Z-axis direction. Each of sides 11 to 14 of radiating element 121 is provided with a notch 121a so as not to be in contact with external connection terminals 21 to 24 (e.g., each of the sides 11 to 14 includes a gap between the radiating element 121 and a corresponding one of the external connection terminals 21 to 24). Specifically, side 11 and side 13 are connected to each other by a curved portion 15, side 12 and side 13 are connected to each other by a curved portion 16, side 12 and side 14 are connected to each other by a curved portion 17, and side 11 and side 14 are connected to each other by a curved portion 18 (e.g., each of the curved portions 15 to 18 is concave with respect to the center of radiating element 121).

External connection terminals 21 to 24 are provided with electrode portions 21a to 24a, respectively, arranged at main surface 30a of dielectric 30, respectively (e.g., each of the electrode portions 21a to 24a may be on the main surface 30a of dielectric 30). Electrode portion 21a is arranged on the main surface 30a at a predetermined distance (e.g., spaced apart) from curved portion 15 in an area between a virtual intersection 150 of a virtual straight line overlapping (e.g., collinear) with side 11 and a virtual straight line overlapping with side 13 and curved portion 15 (e.g., the curved portion 15 is between the electrode portion 21a and the center of the radiating element 121). Electrode portion 22a is arranged on the main surface 30a at a predetermined distance (e.g., spaced apart) from curved portion 16 in an area between a virtual intersection 160 of a virtual straight line overlapping with side 12 and the virtual straight line overlapping with side 13 and curved portion 16 (e.g., the curved portion 16 is between the electrode portion 22a and the center of the radiating element 121). Electrode portion 23a is arranged on the main surface 30a at a predetermined distance (e.g., spaced apart) from curved portion 18 in an area between a virtual intersection 180 of the virtual straight line overlapping with side 11 and a virtual straight line overlapping with side 14 and curved portion 18 (e.g., the curved portion 18 is between the electrode portion 23a and the center of the radiating element 121). Electrode portion 24a is arranged on the main surface 30a at a predetermined distance (e.g., spaced apart) from curved portion 17 in an area between a virtual intersection 170 of the virtual straight line overlapping with side 12 and the virtual straight line overlapping with side 14 and curved portion 17 (e.g., the curved portion 17 is between the electrode portion 24a and the center of the radiating element 121). For example, referring to FIG. 3, each of the electrode portions 21a to 24a is spaced apart from a corresponding curved portion 15 to 18, such that a portion of the dielectric 30 (i.e., a portion of the main surface 30a of the dielectric 30) is between each of the electrode portions 21a to 24a and a corresponding curved portion 15 to 18 (e.g., a portion of the main surface 30a of the dielectric 30 is between each of the electrode portions 21a to 24a and the radiating element 121).

Thus, each of electrode portions 21a to 24a of external connection terminals 21 to 24 does not overlap with radiating element 121 when viewed from the Z-axis direction and overlaps with radiating element 121 when viewed from both of the X-axis direction and the Y-axis direction. With such an arrangement, the distance between each of external connection terminals 21 to 24 and radiating element 121 is short, so that antenna substrate 20 can be reduced in size and electric field between each of external connection terminals 21 to 24 and radiating element 121 becomes large, which facilitates formation of a capacitance. As compared to an example where each of external connection terminals 21 to 24 is arranged at a position more distant from radiating element 121 than in the present disclosure (for example, a position where each of the external connection terminals overlaps with radiating element 121 only when viewed from one of the two directions orthogonal to the Z-axis direction and orthogonal to each other and does not overlap with radiating element 121 when viewed from the other of the two directions), antenna coverage may be expanded while the antenna substrate may increase in size.

In the present embodiment, external connection terminal 21 and external connection terminal 22 are arranged in line symmetry with respect to straight line P2. External connection terminal 23 and external connection terminal 24 are arranged in line symmetry with respect to straight line P2. External connection terminal 21 and external connection terminal 23 are arranged in line symmetry with respect to straight line P1. External connection terminal 22 and external connection terminal 24 are arranged in line symmetry with respect to straight line P1. Furthermore, external connection terminals 21 to 24 according to the present embodiment are arranged in rotation symmetry with respect to a straight line Z0 extending in the Z-axis direction from the center of radiating element 121. With such an arrangement, symmetry of electric field can be good. Displacement of directivity of radio waves from the Z-axis direction can thus be suppressed.

When antenna substrate 20 is viewed from the Z-axis direction, the distance between each of external connection terminals 21 to 24 and an end of radiating element 121 (i.e., a corresponding curved portion) is less than half a size of radiating element 121 in the polarization direction of radiating element 121. For example, as shown in FIG. 3, a relational expression of D₁ < S₁/2 is held where D₁ represents the distance between the end (electrode portion 22a) of external connection terminal 22 and the end (curved portion 16) of radiating element 121 and S₁ represents the size (e.g., a length) of radiating element 121 in the Y-axis direction. The distance between the end of each of external connection terminals 21 to 24 and the end of radiating element 121 is less than λ/4, λ representing a wavelength in the substrate, of a radio-frequency signal supplied to radiating element 121. In other words, a relational expression of D₁ < λ/4 is held. By setting such a distance, capacitive coupling between each of external connection terminals 21 to 24 and radiating element 121 can be strengthened.

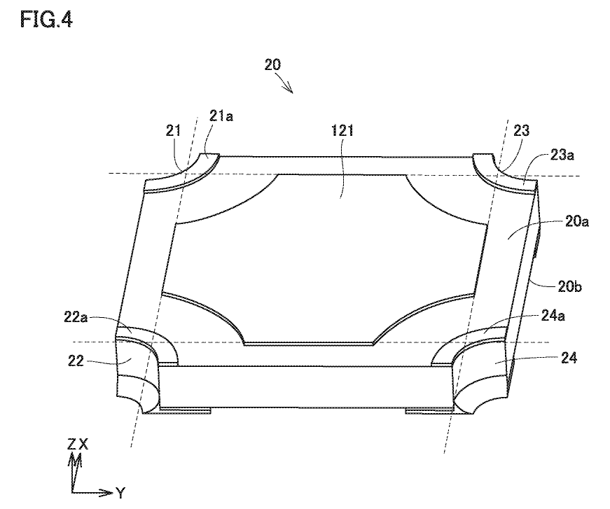

Though FIG. 3 shows an example in which the sizes (e.g., lengths) of radiating element 121 in the X-axis direction and the Y-axis direction match with the sizes of dielectric 30 in the X-axis direction and the Y-axis direction, the size of radiating element 121 is not limited as such. In other words, as long as at least a part of each of external connection terminals 21 to 24 overlaps with radiating element 121 when viewed from both of the X-axis direction and the Y-axis direction, the size of radiating element 121 is not particularly limited. For example, as shown in FIG. 4, radiating element 121 may be smaller in size in the X-axis direction and the Y-axis direction than dielectric 30.

### Antenna Characteristics

In antenna substrate 20 according to the present embodiment, not only radiating element 121 but also electrode portion 21a of external connection terminal 21 is arranged at main surface 30a of dielectric 30. Electrode portion 21a does not overlap with radiating element 121 when viewed from the Z-axis direction and overlaps with radiating element 121 when viewed from both of the X-axis direction and the Y-axis direction.

In other words, though electrode portion 21a of external connection terminal 21 is distant (e.g., spaced apart or separated) from radiating element 121, it is arranged at a position in the same layer as radiating element 121 (e.g., surfaces of the electrode portion 21a and the radiating element 121 that face the main surface 30a of the dielectric 30 may be level with each other) and close to radiating element 121. Therefore, a capacitance can be formed between electrode portion 21a of external connection terminal 21 and the end (curved portion 15) of radiating element 121. External connection terminal 21 is partially exposed at side surface 30b of dielectric 30 and includes a portion extending between radiating element 121 and ground electrode GND in the Z-axis direction (e.g., the external connection terminal 21 may include a lower end extending along a surface of the dielectric 30 opposite the main surface 30a and a side portion connecting the lower end and the electrode portion 21a at the curved portion 15). With such arrangement of external connection terminal 21, the capacitance between radiating element 121 and ground electrode GND can be adjusted.

Similarly to electrode portion 21a of external connection terminal 21, electrode portions 22a to 24a of external connection terminals 22 to 24 do not overlap with radiating element 121 when viewed from the Z-axis direction and overlap with radiating element 121 when viewed from both of the X-axis direction and the Y-axis direction. Therefore, similarly to external connection terminal 21, also with arrangement of external connection terminals 22 to 24, the capacitance between radiating element 121 and ground electrode GND can be adjusted.

Lower ends of external connection terminals 21 to 24 may directly be connected to ground electrode GND of base substrate 10 (e.g., referring to FIG. 2, via a connection extending from the lower end of the external connection terminal 22, into a portion of the dielectric 30, to contact the ground electrode GND), or do not have to directly be connected to ground electrode GND. The number of external connection terminals is not necessarily limited to four and should only be set to one or more. In any case, the capacitance between radiating element 121 and ground electrode GND can be adjusted. Through such adjustment of the capacitance, coverage of antenna substrate 20 can be expanded.

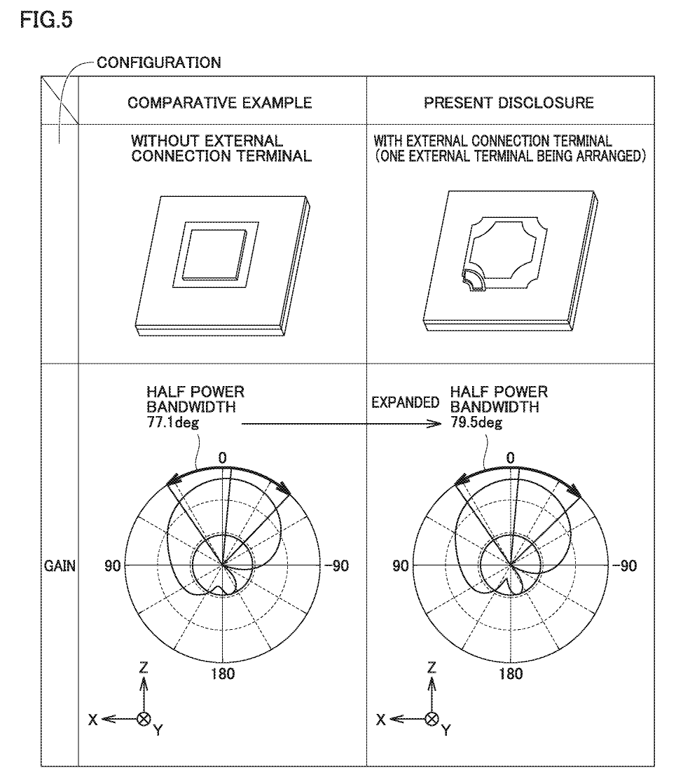

FIG. 5 is a diagram (No. 1) showing antenna characteristics when the antenna configuration in the present disclosure is employed. On the right side in FIG. 5, a configuration and a graph of an antenna gain in the present disclosure are shown, and on the left side in FIG. 5, a configuration and a graph of an antenna gain in a comparative example are shown. The configuration in the present disclosure in FIG. 5 is such that three of four external connection terminals 21 to 24 of antenna substrate 20 have been removed and only one external connection terminal is arranged and that one external connection terminal is not directly connected to ground electrode GND. The configuration in the comparative example is such that all four external connection terminals 21 to 24 have been removed from antenna substrate 20.

As shown in FIG. 5, in the comparative example in which all external connection terminals have been removed, a half power bandwidth (a point lowered by 3 dB from a peak gain) is 77.1 [deg]. In contrast, in an example where one external connection terminal in the present disclosure is arranged, the half power bandwidth is 79.5 [deg], which is larger than in the comparative example. Thus, even when only a single external connection terminal in the present disclosure is arranged, coverage can be larger than in the example without the external connection terminal in the present disclosure.

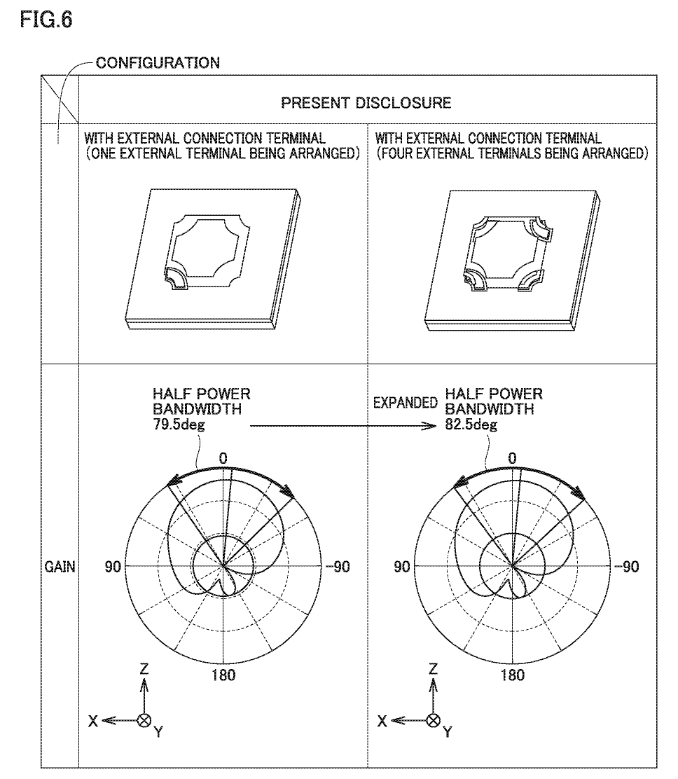

FIG. 6 is a diagram (No. 2) showing antenna characteristics when the antenna configuration in the present disclosure is employed. On the right side in FIG. 6, the configuration of antenna substrate 20 in which four external connection terminals 21 to 24 are arranged and a graph of antenna gain are shown, and on the left side in FIG. 6, a configuration in which three of four external connection terminals 21 to 24 have been removed and only one external connection terminal is arranged and a graph of antenna gain (that is, the same graph as the graph shown on the right side in FIG. 5) are shown. In the configuration in FIG. 6, none of the external connection terminals are directly connected to ground electrode GND.

As shown in FIG. 6, when only a single external connection terminal in the present disclosure is arranged, the half-power bandwidth is 79.5 [deg]. In contrast, when four external connection terminals in the present disclosure are arranged, the half-power bandwidth is 82.5 [deg], which is larger than in the example where only a single external connection terminal is arranged. By thus arranging four external connection terminals in the present disclosure, coverage can further be larger than in the example where only a single external connection terminal in the present disclosure is arranged.

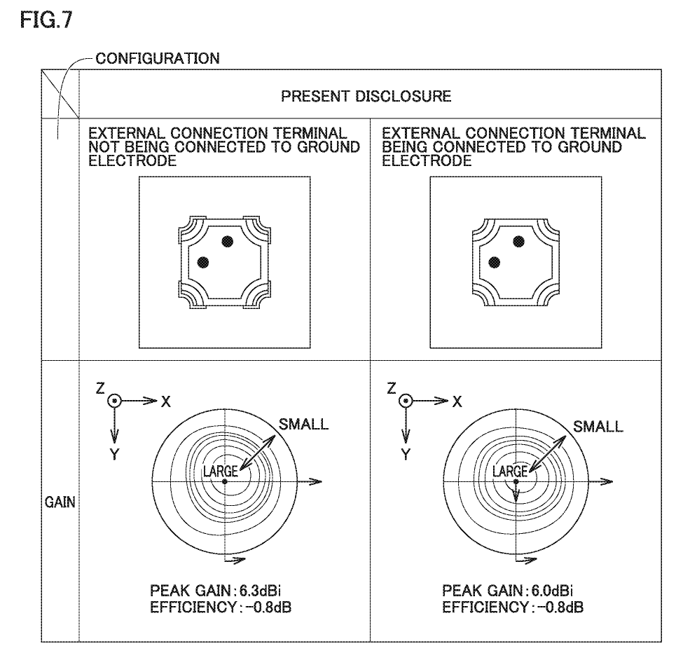

FIG. 7 is a diagram (No. 3) showing antenna characteristics when the antenna configuration in the present disclosure is employed. On the left side in FIG. 7, the antenna gain in an example where four external connection terminals 21 to 24 are not connected to ground electrode GND is shown in a contour graph, and on the right side in FIG. 7, the antenna gain in an example where four external connection terminals 21 to 24 are connected to ground electrode GND is shown in a contour graph.

As shown in FIG. 7, in the example where external connection terminals 21 to 24 are not connected to ground electrode GND, the peak gain is 6.3 [dBi] and antenna efficiency is -0.8 [dB]. In contrast, in the example where external connection terminals 21 to 24 are connected to ground electrode GND, the peak gain is 6.0 [dBi] and antenna efficiency is -0.8 [dB]. In other words, in the example where external connection terminals 21 to 24 are connected to ground electrode GND, though the peak gain is lower than in the example where external connection terminals 21 to 24 are not connected to ground electrode GND, antenna efficiency is the same. It can be understood from this result that, by connecting the external connection terminals to ground electrode GND, as compared to the example where the external connection terminals are not connected to ground electrode GND, coverage can be expanded in the XY-axis directions (lateral direction) while directivity in the Z-axis direction (upward direction) and antenna efficiency are maintained

All of external connection terminals 21 to 24 do not necessarily have to be connected to ground electrode GND. In other words, even when at least one of external connection terminals 21 to 24 is connected to ground electrode GND, it can be expected that the effect of expansion of coverage can more readily be achieved than in the example where external connection terminals 21 to 24 are not connected to ground electrode GND.

As described above, in antenna substrate 20 according to the present embodiment, external connection terminals 21 to 24 include electrode portions 21a to 24a that do not overlap with radiating element 121 when viewed from the Z-axis direction and overlap with radiating element 121 when viewed from both of the X-axis direction and the Y-axis direction. Coverage can thus be expanded while antenna substrate 20 is reduced in size.

"Radiating element 121" and "dielectric 30" in the present embodiment can correspond to the "radiating element" and the "dielectric" in the present disclosure, respectively.

"First power feed point SP1" and "second power feed point SP2" in the present embodiment can correspond to the "first power feed point" and the "second power feed point" in the present disclosure, respectively.

"External connection terminal 21" in the present embodiment can correspond to the "first terminal" in the present disclosure. "External connection terminals 22 to 24" in the present embodiment can correspond to the "second to fourth terminals" in the present disclosure, respectively.

"Ground electrode GND" in the present embodiment can correspond to the "ground electrode" in the present disclosure.

A "Z axis," an "X axis," and a "Y axis" in the present embodiment can correspond to the "first direction," the "second direction," and the "third direction" in the present disclosure, respectively.

### First Modification

In the embodiment described above, an example is shown in which power is directly fed (wired power feed) from power feed lines L1 and L2 to radiating element 121 by connection of power feed lines L1 and L2 to radiating element 121.

In contrast, in the present first modification, power is capacitively fed (wireless power feed) from external connection terminals 21 and 22 to radiating element 121 by connection of power feed lines L1 and L2 to external connection terminals 21 and 22, respectively.

The polarization direction of a first radio wave radiated from radiating element 121 when a radio-frequency signal for first polarization is supplied to external connection terminal 21 is a direction along a straight line connecting external connection terminal 21 and the center of radiating element 121 to each other. The polarization direction of a second radio wave radiated from radiating element 121 when a radio-frequency signal for second polarization is supplied to external connection terminal 22 is a direction along a straight line connecting external connection terminal 22 and the center of radiating element 121 to each other. The straight line connecting external connection terminal 21 and the center of radiating element 121 to each other and the straight line connecting external connection terminal 22 and the center of radiating element 121 to each other are orthogonal to each other. In other words, the polarization direction of the first radio wave and the polarization direction of the second radio wave are orthogonal to each other.

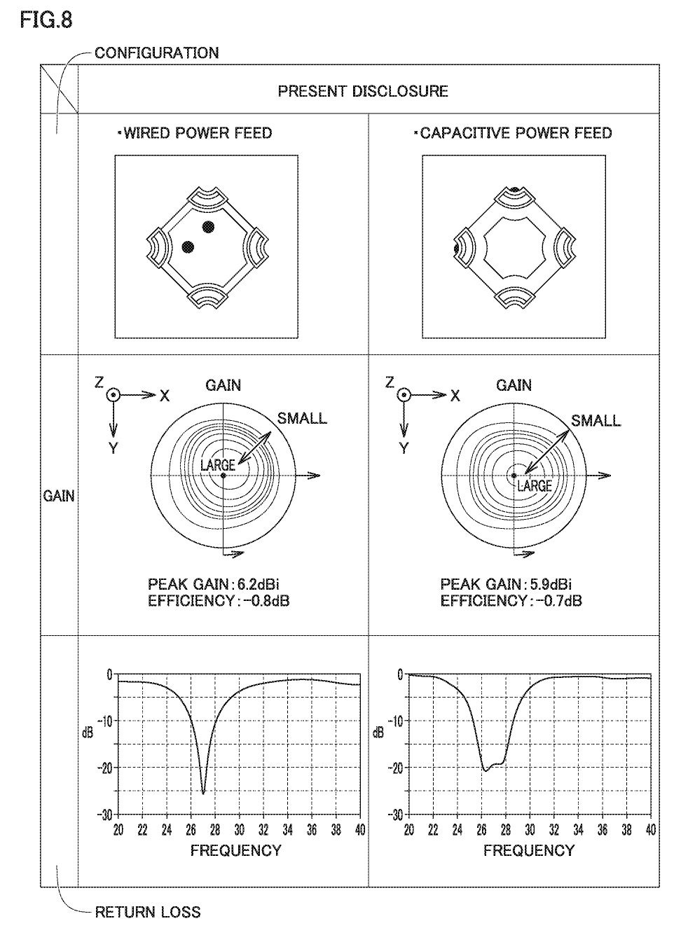

FIG. 8 is a diagram showing antenna characteristics in wired power feed (in the embodiment described above) and antenna characteristics in capacitive power feed (in the present first modification). In FIG. 8, overview of the configuration is shown in the upper tier, an antenna gain is shown in a contour graph in the middle tier, and return loss is shown in the lower tier.

As shown in the upper tier in FIG. 8, the size of the radiating element in capacitive power feed is smaller than in wired power feed, which results from adjustment to set a resonance frequency to be equal between capacitive power feed and wired power feed. In other words, when power is capacitively fed from the external connection terminal to the radiating element, a new capacitance component is generated in a power feed portion between the external connection terminal and the radiating element, so that overall balance between the capacitance component and a reactance component changes as compared to that in wired power feed. With this influence, when an attempt is made to adjust the resonance frequency in capacitive power feed to be equal to that in wired power feed, the size of the radiating element in capacitive power feed becomes smaller than in wired power feed.

As shown in FIG. 8, in wired power feed, the peak gain is 6.2 [dBi] and antenna efficiency is -0.8 [dB]. In contrast, in capacitive power feed, as compared to wired power feed, though the peak gain is lowered to 5.9 [dBi], antenna efficiency is improved to -0.7 [dB]. Furthermore, the return loss in capacitive power feed is not so different from that in wired power feed. From this difference in characteristics, it can be understood that, in capacitive power feed as compared to wired power feed, coverage can be expanded in the XY-axis directions (lateral direction) while directivity in the Z-axis direction (upward direction) is maintained and antenna efficiency is improved.

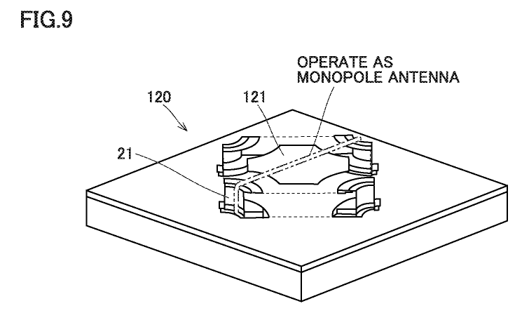

FIG. 9 is a diagram schematically showing an operation mode in capacitive power feed from external connection terminal 21 to radiating element 121. In this case, in addition to a mode in which radiating element 121 operates as a patch antenna, there is a mode in which external connection terminal 21 and radiating element 121 operate as one monopole antenna as shown in FIG. 9. It is estimated that, with this influence, there is a difference in antenna characteristics as shown in FIG. 8.

"External connection terminal 21" and "power feed line L1" in the present first modification can correspond to the "first terminal" and the "first power feed line" in the present disclosure, respectively. "External connection terminal 22" and "power feed line L2" in the present first modification can correspond to the "second terminal" and the "second power feed line" in the present disclosure, respectively.

### Second Modification

In the embodiment described above, a single power feed line L1 may be branched into two and connected to two adjacent radiating elements 121. Similarly, a single power feed line L2 may be branched into two and connected to two adjacent radiating elements 121.

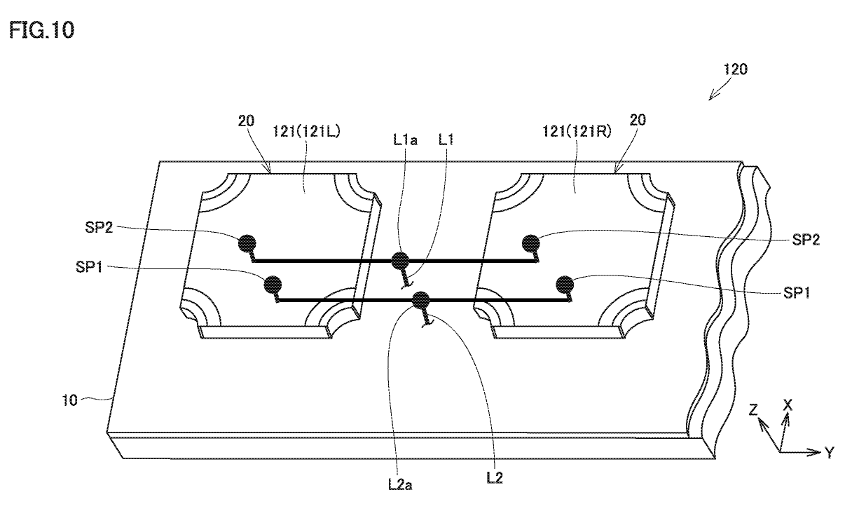

FIG. 10 is a diagram (No. 1) showing an exemplary antenna configuration according to the present second modification. FIG. 10 shows an example of wired power feed from underneath radiating element 121 to radiating element 121.

As shown in FIG. 10, power feed line L1 is branched into two at a branch portion L1a and connected to first power feed points SP2 of two adjacent radiating elements 121. Branch portion L1a is arranged at a position between two adjacent radiating elements 121 when viewed from the Z-axis direction. With such a configuration, a transmission line for a radio-frequency signal for first polarization can be shortened to suppress loss.

Similarly, power feed line L2 is branched into two at a branch portion L2a and connected to second power feed points SP1 of two adjacent radiating elements 121. Branch portion L2a is arranged at a position between two adjacent radiating elements 121 when viewed from the Z-axis direction. With such a configuration, a transmission line for a radio-frequency signal for second polarization can be shortened to suppress loss.

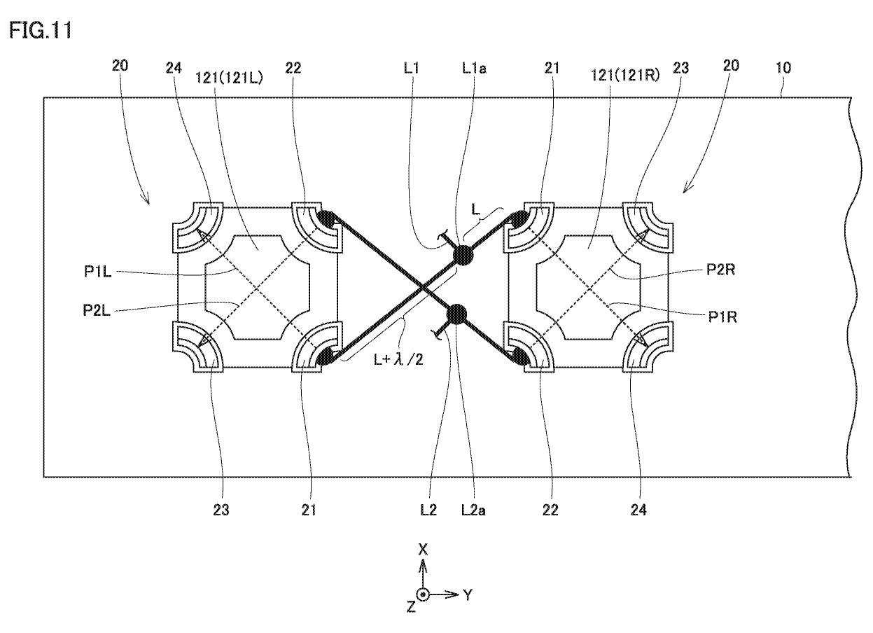

FIG. 11 is a diagram (No. 2) showing an exemplary antenna configuration according to the present second modification. FIG. 11 shows an example of capacitive power feed from external connection terminals 21 and 22 to radiating element 121.

In FIG. 11, two radiating elements 121 adjacent to each other are denoted as a "first radiating element 121R" and a "second radiating element 121L." In FIG. 11, external connection terminal 21 of first radiating element 121R and external connection terminal 21 of second radiating element 121L are connected to a single power feed line L1 with branch portion L1a being interposed. Branch portion L1a is arranged at a position between first radiating element 121R and second radiating element 121L when viewed from the Z-axis direction. Therefore, the transmission line for the radio-frequency signal for first polarization can be shortened to suppress loss.

Similarly, external connection terminal 22 of first radiating element 121R and external connection terminal 22 of second radiating element 121L are connected to a single power feed line L2 with branch portion L2a being interposed. Branch portion L2a is arranged at a position between first radiating element 121R and second radiating element 121L when viewed from the Z-axis direction. Therefore, the transmission line for the radio-frequency signal for second polarization can be shortened to suppress loss.

A straight line P1R connecting external connection terminal 21 of first radiating element 121R and the center of first radiating element 121R to each other is in parallel to a straight line P1L connecting external connection terminal 21 of second radiating element 121L and the center of second radiating element 121L to each other. Therefore, the polarization direction of the first radio wave radiated from first radiating element 121R and the polarization direction of the first radio wave radiated from second radiating element 121L can match with each other.

A power feed line length between branch portion L1a and external connection terminal 21 of second radiating element 121L is set to "L + λ/2" where L represents a power feed line length between branch portion L1a and external connection terminal 21 of first radiating element 121R. Lambda represents a wavelength (electrical length) of the radio-frequency signal in antenna substrate 20. By arranging branch portion L1a at such a position, the first radio wave radiated from first radiating element 121R and the first radio wave radiated from second radiating element 121L can be in phase.

Similarly, a straight line P2R connecting external connection terminal 22 of first radiating element 121R and the center of first radiating element 121R to each other is in parallel to a straight line P2L connecting external connection terminal 22 of second radiating element 121L and the center of second radiating element 121L to each other. Therefore, the polarization direction of the second radio wave radiated from first radiating element 121R and the polarization direction of the second radio wave radiated from second radiating element 121L can match with each other.

The power feed line length between branch portion L2a and external connection terminal 22 of second radiating element 121L is set to "L + λ/2" where L represents the power feed line length between branch portion L2a and external connection terminal 22 of first radiating element 121R. By arranging branch portion L2a at such a position, the second radio wave radiated from first radiating element 121R and the second radio wave radiated from second radiating element 121L can be in phase.

"First radiating element 121R" and "second radiating element 121L" in the present second modification can correspond to the "first radiating element" and the "second radiating element" in the present disclosure, respectively.

"Power feed line L1" and "branch portion L1a" in the present second modification can correspond to the "single power feed line" and the "branch portion" in the present disclosure, respectively.

"Straight line P1R" and "straight line P1L" in the present second modification can correspond to the "straight line connecting the center in the first radiating element and the first terminal to each other" and the "straight line connecting the center in the second radiating element and the first terminal to each other" in the present disclosure, respectively.

### Third Modification

In capacitive power feed from external connection terminals 21 and 22 to radiating element 121, the front and the back of antenna substrate 20 may be identical in design.

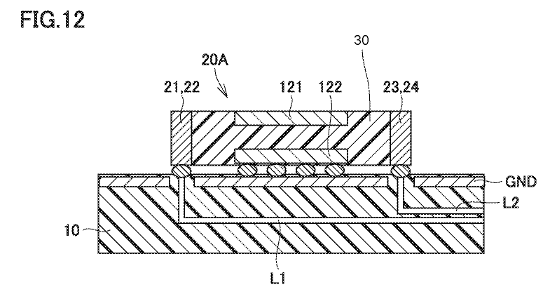

FIG. 12 is a diagram showing an exemplary antenna substrate 20A according to the present third modification. In antenna substrate 20A according to this third modification, radiating element 121 is arranged at a main surface (upper surface) on a front side of dielectric 30, and a specific electrode 122 is arranged at a main surface (lower surface) on a back side of dielectric 30. When antenna substrate 20A is viewed from the Z-axis direction, specific electrode 122 is arranged at a position where it is superimposed on (e.g., overlaps) radiating element 121. In other words, specific electrode 122 is the same in shape as radiating element 121. Electrode portions on an upper surface side and electrode portions on a lower surface side of external connection terminals 21 to 24 are the same in shape.

In other words, antenna substrate 20A is the same in design whether viewed from one main surface side or the other main surface side. Therefore, in mounting antenna substrate 20A on base substrate 10, it is not necessary to identify the front and the back of antenna substrate 20A. Consequently, mounting works can be facilitated and manufacturing cost can accordingly be reduced.

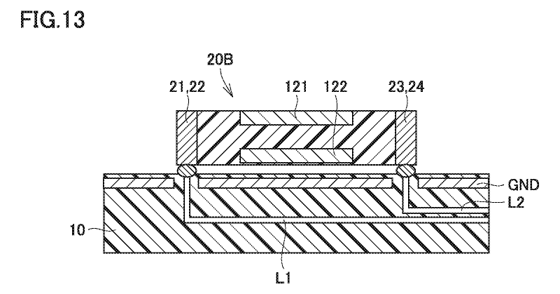

FIG. 12 shows an example in which specific electrode 122 is connected to ground electrode GND. It is assumed, however, that, if specific electrode 122 is connected to ground electrode GND, formation of a capacitance is likely between radiating element 121 and specific electrode 122, which may deteriorate a frequency bandwidth. In consideration of this point, like an antenna substrate 20B shown in FIG. 13, a configuration in which specific electrode 122 is not connected to ground electrode GND may be adopted. By doing so, deterioration of the frequency bandwidth can be suppressed while the front and the back of antenna substrate 20B are the same in design.

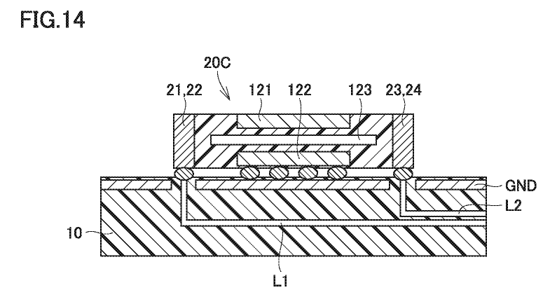

Alternatively, like an antenna substrate 20C shown in FIG. 14, a parasitic element 123 larger than radiating element 121 and specific electrode 122 may be arranged at the center between radiating element 121 and specific electrode 122. The frequency bandwidth can thus be adjusted with parasitic element 123 while the front and the back of antenna substrate 20C are the same in design.

By power feed to parasitic element 123, it may serve as a second radiating element. In this case, by vertically stacking (layering) radiating elements (patches) 121 and 123 different in size (e.g., length), dual bands can be supported.

"Specific electrode 122" and "ground electrode GND" in the present third modification can correspond to the "specific electrode" and the "ground electrode" in the present disclosure, respectively.

### Fourth Modification

In antenna substrate 20 according to the embodiment described above, the shape of radiating element 121 when viewed from the Z-axis direction is such that four corners of a square are cut to be curved. The shape of radiating element 121 when viewed from the Z-axis direction, however, is not limited to the shape shown in the embodiment described above. Furthermore, the shape of each of external connection terminals 21 to 24 when viewed from the Z-axis direction is not limited either to the shape shown in the embodiment described above.

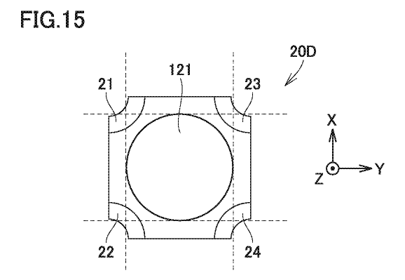

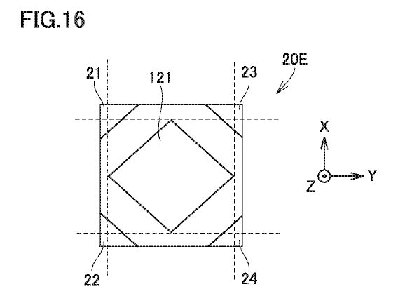

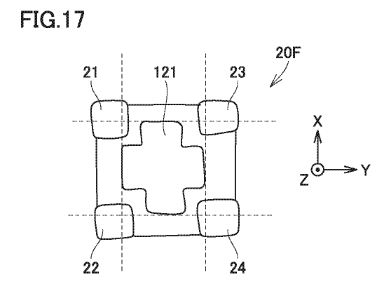

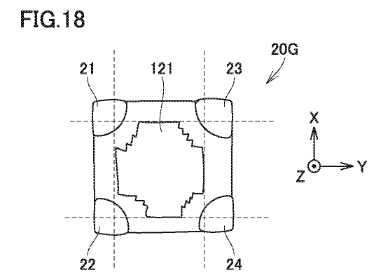

For example, like an antenna substrate 20D shown in FIG. 15, radiating element 121 when viewed from the Z-axis direction may be in a circular shape. Alternatively, like an antenna substrate 20E shown in FIG. 16, radiating element 121 when viewed from the Z-axis direction may be in a square shape. Alternatively, like an antenna substrate 20F shown in FIG. 17, radiating element 121 when viewed from the Z-axis direction may be in a substantially cross shape. Alternatively, like an antenna substrate 20G shown in FIG. 18, radiating element 121 when viewed from the Z-axis direction may be in such a shape that four corners of a square are cut as being serrated.

In any of FIGS. 15 to 18, external connection terminals 21 to 24 should only be arranged at positions where they do not overlap with radiating element 121 when viewed from the Z-axis direction and overlap with radiating element 121 when viewed from both of two directions (the X-axis direction and the Y-axis direction) orthogonal to the Z-axis direction and orthogonal to each other. As long as external connection terminals 21 to 24 are arranged at such positions, the shape of external connection terminals 21 to 24 when viewed from the Z-axis direction is not particularly limited.

### Fifth Modification

With antenna substrate 20 according to the first embodiment described above being defined as a first antenna substrate, a second antenna substrate the same in configuration as the first antenna substrate may be stacked on the first antenna substrate.

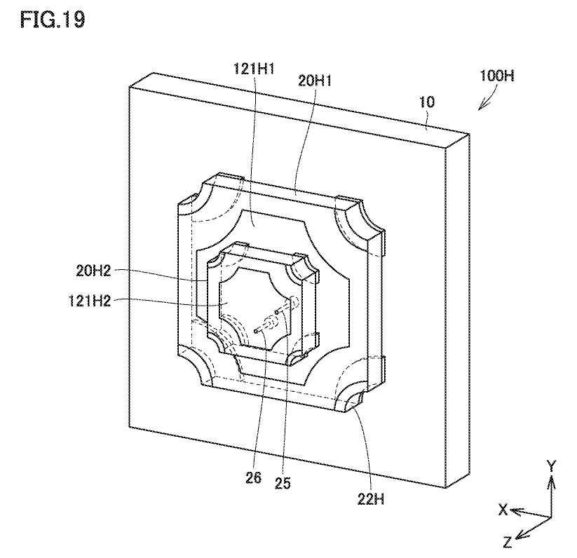

FIG. 19 is a partial perspective view of an antenna module 100H according to the present fifth modification. Antenna module 100H includes base substrate 10, a first antenna substrate 20H1, and a second antenna substrate 20H2.

First antenna substrate 20H1 is arranged on base substrate 10. First antenna substrate 20H1 is similar in configuration to above-described antenna substrate 20. A radiating element 121H1 of first antenna substrate 20H1 is a dual polarization type antenna element configured to radiate radio waves polarized in the X-axis direction and radio waves polarized in the Y-axis direction.

Second antenna substrate 20H2 is arranged on first antenna substrate 20H1. In the example shown in FIG. 19, second antenna substrate 20H2 is mounted on radiating element 121 of first antenna substrate 20H1 by solder connection or another connection method.

Second antenna substrate 20H2 is similar in configuration to antenna substrate 20 described above, that is, to first antenna substrate 20H1. Second antenna substrate 20H2, however, is smaller than first antenna substrate 20H1. In other words, a radiating element 121H2 of second antenna substrate 20H2 is smaller (e.g., smaller area) than radiating element 121H1 of first antenna substrate 20H1.

Similarly to radiating element 121H1 of first antenna substrate 20H1, radiating element 121H2 of second antenna substrate 20H2 is configured to radiate radio waves polarized in the X-axis direction and radio waves polarized in the Y-axis direction.

Power is fed to radiating element 121H2 of second antenna substrate 20H2 from power feed vias 25 and 26 each passing through first antenna substrate 20H1 and extending in the Z-axis direction. Though FIG. 19 shows an example in which tip ends of power feed vias 25 and 26 are connected to radiating element 121H2 to directly feed power from power feed vias 25 and 26 to radiating element 121H2, a capacitive power feed electrode may be arranged at the tip ends of power feed vias 25 and 26 to wirelessly capacitively feed power from the capacitive power feed electrode to radiating element 121H2.

With the configuration as above, the frequency of radio waves radiated from radiating element 121H2 of second antenna substrate 20H2 can be higher than the frequency of radio waves radiated from radiating element 121H1 of first antenna substrate 20H1. In other words, antenna module 100H can adapt to dual bands.

Since second antenna substrate 20H2 is smaller than first antenna substrate 20H1, antenna module 100H can be smaller in size than in an example where two antenna substrates of the same size are stacked. Furthermore, since a proportion of the dielectric occupying around radiating element 121H2 of second antenna substrate 20H2 becomes lower, an effective dielectric constant around radiating element 121H2 can be suppressed. The frequency bandwidth of radio waves radiated by radiating element 121H2 can thus be expanded.

Though an example is shown in which two antenna substrates 20H1 and 20H2 are stacked in antenna module 100H shown in FIG. 19, the number of stacked antenna substrates may be set to three or more. Multiple bands where radio waves having three or more different frequencies can be radiated can thus be supported.

Though the polarization directions of radio waves radiated from two stacked antenna substrates 20H1 and 20H2 are the same in antenna module 100H shown in FIG. 19, the polarization directions of radio waves radiated from the two stacked antenna substrates may be different from each other.

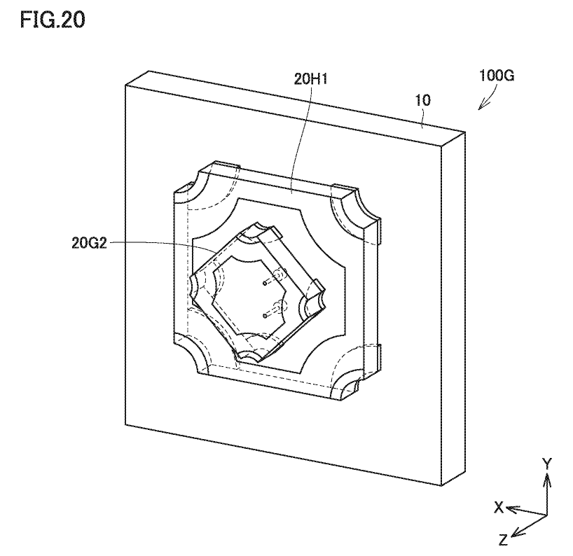

FIG. 20 is a partial perspective view of an antenna module 100G according to the present fifth modification. Antenna module 100Gshown in FIG. 20 is obtained by changing second antenna substrate 20H2 of antenna module 100H shown in FIG. 19 described above to a second antenna substrate 20G2. Second antenna substrate 20G2 is obtained by rotating second antenna substrate 20H2 shown in FIG. 19 described above by 45° counterclockwise when viewed from the positive direction along the Z axis. The polarization direction of radio waves radiated from first antenna substrate 20H1 and the polarization direction of radio waves radiated from second antenna substrate 20G2 can thus be different from each other. Specifically, while the polarization directions of radio waves radiated from first antenna substrate 20H1 are set to the X-axis direction and the Y-axis direction, the polarization directions of radio waves radiated from second antenna substrate 20G2 can be set to a direction inclined diagonally by 45° counterclockwise with respect to the X-axis direction and a direction inclined diagonally by 45° counterclockwise with respect to the Y-axis direction.

It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

The embodiments and the modifications thereof described above are understood by a person skilled in the art as specific examples of aspects below.

1. An antenna substrate according to the present disclosure includes a plate-shaped radiating element arranged in parallel to a main surface of a plate-shaped dielectric and a first terminal arranged as being exposed at least partially at a side surface of the dielectric. With a direction of normal to the radiating element being defined as a first direction and with two directions orthogonal to the first direction and orthogonal to each other being defined as a second direction and a third direction, the first terminal includes a portion that does not overlap with the radiating element when viewed from the first direction and overlaps with the radiating element when viewed from both of the second direction and the third direction.

2. The antenna substrate described in (1) further includes, in addition to the first terminal, a second terminal, a third terminal, and a fourth terminal each arranged as being exposed at least partially at the side surface of the dielectric. Each of the second to fourth terminals includes a portion that does not overlap with the radiating element when viewed from the first direction and overlaps with the radiating element when viewed from both of the second direction and the third direction.

3. In the antenna substrate described in (2), the radiating element is arranged as being opposed to a ground electrode. At least one of the first to fourth terminals is connected to the ground electrode.

4. In the antenna substrate described in any one of (1) to (3), the first terminal is connected to a first power feed line for supplying a radio-frequency signal to the radiating element.

5. In the antenna substrate described in (4), the second terminal is connected to a second power feed line for supplying a radio-frequency signal to the radiating element. When viewed from the first direction, a straight line connecting the first terminal and a center of the radiating element to each other is orthogonal to a straight line connecting the second terminal and the center of the radiating element to each other.

6. The antenna substrate described in any one of (1) to (5) includes a plurality of combinations of the radiating element and the first terminal. Two radiating elements adjacent to each other are connected to a single power feed line with a branch portion being interposed. The branch portion is arranged at a position between the two radiating elements adjacent to each other.

7. The antenna substrate described in any one of (1) to (5) includes a plurality of combinations of the radiating element and the first terminal. With two radiating elements adjacent to each other being defined as a first radiating element and a second radiating element, the first terminal of the first radiating element and the first terminal of the second radiating element are connected to a single power feed line with a branch portion being interposed. The branch portion is arranged at a position between the first radiating element and the second radiating element when viewed from the first direction. A straight line connecting a center in the first radiating element and the first terminal to each other and a straight line connecting a center in the second radiating element and the first terminal to each other are in parallel to each other.

8. The antenna substrate described in any one of (1) to (7) further includes a specific electrode arranged at a position where the specific electrode overlaps with the radiating element when viewed from the first direction.

9. In the antenna substrate described in (8), the radiating element is arranged as being opposed to a ground electrode. The specific electrode is not connected to the ground electrode.

10. The antenna substrate described in (1) further includes a second terminal arranged as being exposed at least partially at the side surface of the dielectric. The first terminal and the second terminal are arranged in line symmetry with respect to a straight line in parallel to a polarization direction of the radiating element.

11. In the antenna substrate described in (2) or (3), the first to fourth terminals are arranged in rotation symmetry with respect to a straight line extending in the first direction from a center of the radiating element.

12. In the antenna substrate described in (11), the radiating element has a shape having a first side, a second side opposed to the first side, and a third side and a fourth side extending in parallel to each other and being orthogonal to the first side when viewed from the first direction. The first terminal includes a portion arranged between the radiating element and an intersection of a straight line overlapping with the first side and a straight line overlapping with the third side. The second terminal includes a portion arranged between the radiating element and an intersection of a straight line overlapping with the second side and the straight line overlapping with the third side. The third terminal includes a portion arranged between the radiating element and an intersection of the straight line overlapping with the first side and a straight line overlapping with the fourth side. The fourth terminal includes a portion arranged between the radiating element and an intersection of the straight line overlapping with the second side and the straight line overlapping with the fourth side.

13. In the antenna substrate described in any one of (1) to (3), the radiating element includes a first power feed point connected to a first power feed line for supplying a first radio-frequency signal to the radiating element and a second power feed point connected to a second power feed line for supplying a second radio-frequency signal to the radiating element. A straight line connecting the first power feed point and a center of the radiating element to each other and a straight line connecting the second power feed point and the center of the radiating element to each other are orthogonal to each other.

14. In the antenna substrate described in any one of (1) to (13), when viewed from the first direction, a distance between the first terminal and an end of the radiating element is less than half a size of the radiating element in a polarization direction of the radiating element.

15. In the antenna substrate described in any one of (1) to (13), when viewed from the first direction, a distance between the first terminal and an end of the radiating element is less than λ/4, λ representing a length of a wavelength in the antenna substrate, of a radio-frequency signal supplied to the radiating element.

16. In the antenna substrate described in any one of (1) to (15), the radiating element has a shape having a linear first side when viewed from the first direction. The first side is provided with a notch so as not to be in contact with the first terminal.

17. An antenna module in the present disclosure includes the antenna substrate described in any one of (1) to (16).

18. A communication apparatus in the present disclosure includes the antenna module described in (17).

19. An antenna module in the present disclosure includes a first antenna substrate and a second antenna substrate, each including a configuration of the antenna substrate described in any one of (1) to (16), one of the first antenna substrate and the second antenna substrate being arranged on top of the other.

20. In the antenna module described in (19), a polarization direction of radio waves radiated from the first antenna substrate and a polarization direction of radio waves radiated from the second antenna substrate are different from each other.

By way of summation and review, according to the present disclosure, coverage can be expanded while an antenna substrate including a plate-shaped radiating element arranged at a main surface of a dielectric and a terminal arranged as being exposed at a side surface of the dielectric is reduced in size.

### REFERENCE SIGNS LIST

1 communication apparatus; 10 base substrate; 10a, 30a main surface; 11 to 14 side; 15 to 18 curved portion; 20, 20A to 20G, 20H1, 20H2, 20G2 antenna substrate; 21 to 24 external connection terminal; 21a to 24a electrode portion; 30 dielectric; 30b side surface; 100, 100H, 100G antenna module; 111A to 113H, 117A, 117B switch; 112AR to 112HR low-noise amplifier; 112AT to 112HT power amplifier; 114A to 114H attenuator; 115A to 115H phase shifter; 116A, 116B splitter; 118A, 118B mixer; 119A, 119B amplifier circuit; 120 antenna apparatus; 121 radiating element; 122 specific electrode; 123 parasitic element; GND ground electrode; L1, L2 power feed line; L1a, L2a branch portion; SP1 first power feed point; SP2 second power feed point.

1. An antenna substrate, comprising:
a plate-shaped dielectric with a main surface and a side surface;
a plate-shaped radiating element arranged in parallel to the main surface of the plate-shaped dielectric; and
a first terminal exposed at least partially at the side surface of the dielectric,
wherein with a direction along a normal to the radiating element being defined as a first direction and with two directions orthogonal to the first direction and orthogonal to each other being defined as a second direction and a third direction, the first terminal includes a portion that does not overlap with the radiating element when viewed from the first direction and overlaps with the radiating element when viewed from both of the second direction and the third direction.

2. The antenna substrate according to claim 1, further comprising a second terminal, a third terminal, and a fourth terminal, each being exposed at least partially at the side surface of the dielectric,
wherein each of the second terminal, the third terminal, and the fourth terminal includes a portion that does not overlap with the radiating element when viewed from the first direction and overlaps with the radiating element when viewed from both of the second direction and the third direction.

3. The antenna substrate according to claim 2, wherein:
the radiating element is arranged opposite to a ground electrode, and
at least one of the first terminal, the second terminal, the third terminal, and the fourth terminal is connected to the ground electrode.

4. The antenna substrate according to claim 2, wherein the first terminal, the second terminal, the third terminal, and the fourth terminal are arranged in rotation symmetry with respect to a straight line extending in the first direction from a center of the radiating element.

5. The antenna substrate according to claim 4, wherein:
the radiating element has a shape having a first side, a second side opposite the first side, and a third side and a fourth side extending in parallel to each other and being orthogonal to the first side when viewed from the first direction,
the first terminal includes a portion arranged between the radiating element and an intersection of a straight line overlapping with the first side and a straight line overlapping with the third side,
the second terminal includes a portion arranged between the radiating element and an intersection of a straight line overlapping with the second side and the straight line overlapping with the third side,
the third terminal includes a portion arranged between the radiating element and an intersection of the straight line overlapping with the first side and a straight line overlapping with the fourth side, and
the fourth terminal includes a portion arranged between the radiating element and an intersection of the straight line overlapping with the second side and the straight line overlapping with the fourth side.

6. The antenna substrate according to claim 2, wherein the first terminal is connected to a first power feed line, the first power feed line being configured to supply a radio-frequency signal to the radiating element.

7. The antenna substrate according to claim 6, wherein:
the second terminal is connected to a second power feed line, the second power feed line being configured to supply a radio-frequency signal to the radiating element, and
when viewed from the first direction, a straight line connecting the first terminal and a center of the radiating element to each other is orthogonal to a straight line connecting the second terminal and the center of the radiating element to each other.

8. The antenna substrate according to claim 1, further comprising an additional radiating element and an additional first terminal, wherein:
the radiating element and the additional radiating element are adjacent to each other and are connected to a single power feed line with a branch portion, and
the branch portion is arranged between the radiating element and the additional radiating element.

9. The antenna substrate according to claim 1, further comprising an additional radiating element and an additional first terminal, wherein:
the radiating element and the additional radiating element are adjacent to each other and are defined as a first radiating element and a second radiating element,
the first terminal of the first radiating element and the additional first terminal of the second radiating element are connected to a single power feed line with a branch portion,
the branch portion is between the first radiating element and the second radiating element when viewed from the first direction, and
a straight line connecting a center in the first radiating element and the first terminal to each other and a straight line connecting a center in the second radiating element and the additional first terminal to each other are in parallel to each other.

10. The antenna substrate according to claim 1, further comprising a specific electrode overlapping the radiating element when viewed from the first direction.

11. The antenna substrate according to claim 10, wherein:
the radiating element is opposite to a ground electrode, and
the specific electrode is not connected to the ground electrode.

12. The antenna substrate according to claim 1, further comprising a second terminal exposed at least partially at the side surface of the dielectric, the first terminal and the second terminal being arranged in line symmetry with respect to a straight line in parallel to a polarization direction of the radiating element.

13. The antenna substrate according to claim 1, wherein:
the radiating element includes:
a first power feed point connected to a first power feed line, the first power feed line being configured to supply a first radio-frequency signal to the radiating element, and
a second power feed point connected to a second power feed line, the second power feed line being configured to supply a second radio-frequency signal to the radiating element, and
a straight line connecting the first power feed point and a center of the radiating element to each other and a straight line connecting the second power feed point and the center of the radiating element to each other are orthogonal to each other.

14. The antenna substrate according to claim 1, wherein, when viewed from the first direction, a distance between the first terminal and an end of the radiating element is less than half a size of the radiating element in a polarization direction of the radiating element.

15. The antenna substrate according to claim 1, wherein, when viewed from the first direction, a distance between the first terminal and an end of the radiating element is less than λ/4, λ representing a length of a wavelength in the antenna substrate of a radio-frequency signal supplied to the radiating element.

16. The antenna substrate according to claim 1, wherein:
the radiating element has a shape having a linear first side when viewed from the first direction, and
the first side includes a notch separating the radiating element from the first terminal.

17. An antenna module comprising the antenna substrate according to claim 1.

18. A communication apparatus comprising the antenna module according to claim 17.

19. An antenna module, comprising:
a first antenna substrate and a second antenna substrate, each being the antenna substrate according to claim 1,
wherein one of the first antenna substrate and the second antenna substrate is arranged on top of the other.

20. The antenna module according to claim 19, wherein a polarization direction of radio waves radiated from the first antenna substrate and a polarization direction of radio waves radiated from the second antenna substrate are different from each other.
